(19) United States
(12) Patent Application Publication
(10) Pub. No.: US 2021/0108125 A1
(43) Pub. Date: Apr. 15, 2021

(54) COMPOSITION AND METHOD FOR CONTROLLING BACTERIA IN FORMATIONS

(71) Applicant: BIOTECHNOLOGY SOLUTIONS, LLC, Houston, TX (US)

(72) Inventor: Michael HARLESS, Houston, TX (US)

(21) Appl. No.: 17/132,151

(22) Filed: Dec. 23, 2020

Related U.S. Application Data
(63) Continuation-in-part of application No. 16/804,562, filed on Feb. 28, 2020.
Application No. 16/804,562 is a division of application No. 16/029,963, filed on Jul. 9, 2018, now Pat. No. 10,611,950.
(60) Provisional application No. 62/530,678, filed on Jul. 10, 2017.

(51) Int. Cl. C09K 8/532; E21B 43/26; C09K 8/582

(52) U.S. Cl. CPC C09K 8/532; C09K 2208/20; C09K 8/582; E21B 43/26

(57) ABSTRACT

A process includes growing nitrate reducing bacteria (NRB) in a nitrate reducing bacteria media to form a NRB culture, the NRB being Halomonas sp. The process also includes combining the NRB culture with a concentrated nitrate solution to form a NRB composition, wherein the concentration of nitrate in the NRB is between 0.5% and 50% active nitrate and injecting the NRB composition into a hydrocarbon-bearing formation.

### CROSS-REFERENCE TO RELATED APPLICATIONS

This application is a continuation-in-part of U.S. non-provisional application Ser. No. 16/804,562, filed Feb. 28, 2020. U.S. non-provisional application Ser. No. 16/804,562 is itself a Divisional application of U.S. non-provisional application Ser. No. 16/029,963, which claims priority from U.S. provisional application No. 62/530,678, filed Jul. 10, 2017, all of which are incorporated by reference herein in their entirety.

### FIELD OF THE DISCLOSURE

Embodiments of the present disclosure generally relate to controlling and reducing bacteria, such as sulfate-reducing bacteria (SRB).

### BACKGROUND

Water in hydrocarbon formations may provide a growth media for anaerobic bacteria. Certain anaerobic bacteria, such as SRB, may be problematic in recovery of hydrocarbons from hydrocarbon-bearing formations. For instance, SRB may reduce sulfates to sulfides, which may damage the hydrocarbon-bearing formation. In addition, SRB may form slimes or sludges, reducing the porosity of the formation. Reducing the porosity of the formation may impede recovery of the hydrocarbons from the hydrocarbon-bearing formation. Reduction of porosity may be a particularly acute problem in low porosity formations, such as shale.

Fracturing operations may be used to increase hydrocarbon recovery from hydrocarbon-bearing formations. Fracturing operations make use of fracturing fluids, which are often water-based. In fracturing a high hydraulic pressure is typically used to fracture the subterranean formation, creating cracks that facilitate the increased flow of hydrocarbons. Often, proppants are used to keep cracks open that are created during the fracturing operation. Depending on the formation and the fracturing operation method, water-based fracturing fluid may be retained in the formation for extended periods. For instance, small-pore sized, low-porosity shales may retain a significant amount of water-based fracturing fluid. The water retained in the formation from the fracturing operation may provide a growth media for SRB.

Traditional water-based fracturing fluids may include a biocide to control SRB. However, biocides, in particular long-acting biocides such as glutaraldehyde, may present environmental concerns, such as ground water contamination. Short acting biocides, such as oxidizers, may present less of an environmental hazard, but may not be active over the entire period in which the fracturing fluid is retained by the hydrocarbon-bearing formation.

Further, SRB may be an issue in other oil/gas water systems such as peripheral oil and gas subsystems, including, but not limited to, water impoundment systems, ponds, tanks, and water injection systems. Growth of SRB in such systems may not only retard fluid flow and promote corrosion in such systems but may also be a source of SRB in formations once injected. In addition, Microbial Enhanced Oil Recovery (MEOR) systems may grow SRB. Injection of SRB-containing fluids through the MEOR system into a formation may, like fracturing fluids, damage the formation.

Nitrate-Reducing Bacteria (NRB) may inhibit the growth of SRB by using a more efficient nitrate-reduction metabolic pathway than SRB and removing nutrients from the environment that SRB require in order to grow and produce sulfides. Traditionally, NRB require a high concentration of nitrate in water in the hydrocarbon to be effective and, thereby necessitating large quantities of nitrate to be pumped simultaneously with the NRB into the hydrocarbon-bearing formation or used with water in peripheral oil and gas subsystems.

NRB may also produce biopolymers and gases that mobilize hydrocarbons in the formation during water flooding and may enhance the effectiveness of secondary recovery operations by the process of MEOR.

### SUMMARY

The present disclosure provides for a process that includes growing nitrate reducing bacteria (NRB) in a nitrate reducing bacteria media to form a NRB culture, the NRB being Halomonas sp. The process also includes combining the NRB culture with a concentrated nitrate solution to form a NRB composition, wherein the concentration of nitrate in the NRB is between 0.5% and 50% active nitrate and injecting the NRB composition into a hydrocarbon-bearing formation or an oil/gas water system.

The present disclosure also provides for a NRB composition that includes NRB, the NRB being Halomonas sp., water, and nitrate, the nitrate present in the NRB composition in a concentration of between 10% and 50% active nitrate.

The present disclosure also provides for a process that includes growing nitrate reducing bacteria (NRB), the NRB being Halomonas sp., in a nitrate reducing bacteria media to form a NRB culture and combining the NRB culture with molybdate or molybdate salt to form a NRB composition.

In addition, the present disclosure provides for a process that includes forming a fracturing fluid. Forming the fracturing fluid includes growing nitrate reducing bacteria (NRB) in a nitrate reducing bacteria media to form a NRB culture, the NRB being Halomonas sp. and combining the NRB culture with a concentrated nitrate solution to form a NRB composition, wherein the concentration of nitrate in the NRB is between 0.5% and 50% active nitrate. The process of forming the fracturing fluid also includes combining the NRB culture with an aqueous medium to form the fracturing fluid. Following formation of the fracturing fluid, the process includes injecting the fracturing fluid into a hydrocarbon bearing formation.

The present disclosure provides for process including injecting a nitrate reducing bacteria (NRB) composition into a hydrocarbon-bearing formation or oil/gas water system, the NRB composition including Halomonas sp.

### DETAILED DESCRIPTION

A detailed description will now be provided. The following disclosure includes specific embodiments, versions and examples, but the disclosure is not limited to these embodiments, versions or examples, which are included to enable a person having ordinary skill in the art to make and use the disclosure when the information in this application is combined with available information and technology.

Various terms as used herein are shown below. To the extent a term used in a claim is not defined below, it should be given the broadest definition persons in the pertinent art have given that term as reflected in printed publications and issued patents. Further, unless otherwise specified, all compounds described herein may be substituted or unsubstituted and the listing of compounds includes derivatives thereof

Further, various ranges and/or numerical limitations may be expressly stated below. It should be recognized that unless stated otherwise, it is intended that endpoints are to be interchangeable. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.).

Certain embodiments of the present disclosure relate to a NRB composition, wherein the NRB is Halomonas sp., that includes a nitrate and NRB with a nitrate concentration that is effective in controlling SRB while retaining NRB viability. In certain embodiments, the composition is a solution.

Nitrates included in the NRB composition may be for instance, sodium nitrate, calcium nitrate, potassium nitrate, silver nitrate, or a combination thereof. In certain embodiments, only sodium nitrate is used in the NRB composition. Without being bound by theory, sodium nitrate may allow greater survivability of the NRB than other nitrates. Further, sodium nitrate may be sufficiently soluble in water as to be efficacious in providing nutrients to the NRB of the NRB composition.

In certain embodiments, the amount of active nitrate in the NRB composition may range from 0.5% to 50%, or from 20% to 40% or about 30% (weight of active nitrate to volume of NRB composition). In some embodiments, the amount of NRB culture may range from 5% to 50%, from 10 to 40% or about 30% (volume/volume). The remainder of the NRB composition may be water.

The NRB composition may be prepared by growing NRB in a nitrate reducing bacteria media composed of potassium monophosphate, yeast, sodium nitrate, sodium acetate, sodium lactate, sodium chloride, or other suitable constituents for growth of NRB. The resulting NRB culture may be combined with a concentrated nitrate solution. For example, when the nitrate is sodium nitrate, the concentrated sodium nitrate solution may be between 40 and 70% sodium nitrate, between 50 and 60% sodium nitrate, or about 59% sodium nitrate. In embodiments, nitrate concentration is selected in part at a level below which the nitrate precipitates out of the concentrated nitrate solution.

In some embodiments, the shelf life of the NRB composition is between 30 days and 18 months or between 6 months and 12 months, or at least 30 days. Shelf life refers to time NRB in an NRB composition may remain capable of reproducing when exposed to suitable conditions, such as, temperature, salt concentration, appropriate nutrients, and other environmental factors.

In certain embodiments, SRB inhibitors, such as molybdates and molybdate salts may be used in conjunction with the NRB composition or injected separately. For instance, molybdates may be introduced together with the NRB composition into the formation, such as with a fracturing fluid or at a different time. The molybdates and molybdate salts may include sodium molybdate and lithium molybdate, although any SRB inhibitor may be used. In certain embodiments of the present invention, molybdates and molybdate salts are added to the fracturing fluid in the range of 5 to about 100 ppm, or between 10 and 80 ppm by weight of fluid. In other embodiments, the molybdate and molybdate salts are included in the NRB composition in an amount from 1.5% to 25%, or from 3% to 15% of the NRB composition (by weight of fluid).

In yet other embodiments, the nitrate may be omitted and the NRB composition may include the molybdate/molybdate salt and the NRB. In such embodiments, the molybdate and molybdate salts are included in the NRB composition in an amount from 1.5% to 25%, or from 3% to 15% of the NRB composition (by weight of fluid).

In certain embodiments, the NRB composition may be introduced into a hydrocarbon-producing formation, such as by pumping. In some embodiments, the NRB composition may be introduced into the formation together with a fracturing fluid.

In certain embodiments, the fracturing fluid may include scale inhibitors to reduce scale buildup in the formation or production equipment that may precipitate from the brine used as a base for the fracturing fluid. Polyacrylate polymers, copolymers, and terpolymers, which are combatable with NRBs, may be used in the fracturing fluid.

In another embodiment, NRBs are used in combination with slickwater hydraulic fracturing fluids that include friction reducers. Friction reducers such as latex polymers and copolymers of polyacrylamides are compatible with nitrates and NRBs and may be used in the fracturing fluid.

Thus, in certain embodiments, the NRBs are used in a fracturing operation, such as that described above. In such embodiments, the NRB composition may be combined with an aqueous medium, such as water, to form the fracturing fluid. The fracturing fluid is then injected into the formation. The NRB in the NRB composition may then remain in the formation to retard the growth of SRBs.

In other embodiments, the NRB is used in oil/gas water systems such as peripheral oil and gas subsystems, including, but not limited to, water impoundment systems, ponds, tanks, and water injection systems. In such embodiments, the NRB is combined with the fluid in the peripheral subsystem. In yet other embodiments the NRB is used in or oil/gas water systems such as MEOR systems, such as by combining the NRB with a fluid in the MEOR.

Depending on the context, all references herein to the “disclosure” may in some cases refer to certain specific embodiments only. In other cases it may refer to subject matter recited in one or more, but not necessarily all, of the claims. While the foregoing is directed to embodiments, versions and examples of the present disclosure, which are included to enable a person of ordinary skill in the art to make and use the disclosures when the information in this patent is combined with available information and technology, the disclosures are not limited to only these particular embodiments, versions and examples. Other and further embodiments, versions and examples of the disclosure may be devised without departing from the basic scope thereof and the scope thereof is determined by the claims that follow.

What is claimed is:

1. A process comprising:
growing nitrate reducing bacteria (NRB) in a nitrate reducing bacteria media to form a NRB culture, the NRB being Halomonas sp.;
combining the NRB culture with a concentrated nitrate solution to form a NRB composition, wherein the concentration of nitrate in the NRB is between 0.5% and 50% active nitrate; and
injecting the NRB composition into an oil/gas water system or a hydrocarbon-bearing formation.

2. The process of claim 1, wherein the formation further comprises a fracturing fluid or a produced water.

3. The process of claim 1, wherein the oil/gas water system is a peripheral oil and gas subsystem or an MEOR system.

4. The process of claim 3, wherein the peripheral oil and gas subsystem is a water impoundment system, pond, tank, or water injection system.

5. The process of claim 1 further comprising injecting a molybdate or molybdate salt into the oil/gas water system or the formation.

6. The process of claim 1, wherein the concentration of nitrate in the NRB is about 30% active nitrate.

7. The process of claim 1, wherein the nitrate is sodium nitrate, potassium nitrate, silver nitrate, or calcium nitrate.

8. The process of claim 1, wherein the only NRB present in the NRB composition is Halomonas sp.

9. The process of claim 1, wherein the step of forming an NRB composition further comprises:
adding molybdate or a molybdate salt to the NRB composition.

10. The process of claim 1, wherein the only NRB injected into the oil/gas water system or the hydrocarbon-bearing formation is Halomonas sp.

11. An NRB composition comprising:
NRB, the NRB being Halomonas sp.;
water; and
nitrate, the nitrate present in the NRB composition in a concentration of between 0.5% and 50% active nitrate.

12. The NRB composition of claim 11, wherein the concentration of nitrate in the NRB is about 30% active nitrate.

13. The NRB composition of claim 11, wherein the nitrate is sodium nitrate, potassium nitrate, silver nitrate, or calcium nitrate.

14. The process of claim 11, wherein the only NRB present in the NRB composition is Halomonas sp.

15. A process comprising:
growing nitrate reducing bacteria (NRB) in a nitrate reducing bacteria media to form a NRB culture the NRB being Halomonas sp.;
combining the NRB culture with molybdate or molybdate salt to form a NRB composition.

16. The process of claim 15, wherein the molybdate or molybdate salt is present in the NRB composition in an amount of between 3% and 15% (by volume).

17. The process of claim 15 further comprising:
combining the NRB composition with a concentrated nitrate solution.

18. The process of claim 15, wherein the only NRB present in the NRB composition is Halomonas sp.

19. A process comprising:
forming a fracturing fluid including:
growing nitrate reducing bacteria (NRB) in a nitrate reducing bacteria media to form a NRB culture, the NRB being Halomonas sp.;
and
combining the NRB culture with an aqueous medium to form the fracturing fluid;
injecting the fracturing fluid into a hydrocarbon bearing formation.

20. The process of claim 19, wherein forming the fracturing fluid further comprises adding one or more polyacrylate polymers, copolymers, or terpolymers.

21. The process of claim 19, wherein the fracturing fluid is a slickwater fracturing fluid.

22. The process of claim 21, wherein the process of forming the fracturing fluid further comprises adding one or more latex polymers or copolymers of polyacrylamides.

23. A process comprising:
injecting a nitrate reducing bacteria (NRB) composition into a hydrocarbon-bearing formation or oil/gas water system, the NRB composition including Halomonas sp.

24. The process of claim 23 further comprising prior to the step of injecting the NRB composition:
growing the NRB in a nitrate reducing bacteria media to form a NRB culture.

25. The process of claim 24 comprising:
after forming the NRB culture, combining the NRB culture with a nitrate solution to form the NRB composition.

26. The process of claim 24 further comprising:
combining the NRB culture with an aqueous medium to form a fracturing fluid.

27. The process of claim 23, wherein the oil/gas water system is a peripheral oil and gas subsystem or an MEOR system.

28. The process of claim 23, wherein the peripheral oil and gas subsystem is a water impoundment system, pond, tank, or water injection system.
